(19) United States
(12) Patent Application Publication
(10) Pub. No.: US 2018/0060987 A1
(43) Pub. Date: Mar. 1, 2018

(54) IDENTIFICATION OF ABNORMAL BEHAVIOR IN HUMAN ACTIVITY BASED ON INTERNET OF THINGS COLLECTED DATA

(71) Applicant: International Business Machines Corporation, Armonk, NY (US)

(72) Inventors: CARLOS HENRIQUE CARDONHA, Sao Paulo (BR); VAGNER FIGUEREDO DE SANTANA, Sao Paulo (BR); MARCO AURELIO STELMAR NETTO, Sao Paulo (BR)

(21) Appl. No.: 15/253,044

(22) Filed: Aug. 31, 2016

(51) Int. Cl. G06Q 50/26; G06Q 10/06; G06F 17/30

(52) U.S. Cl. CPC G06Q 50/265; G06F 17/30368; G06F 17/30528; G06Q 10/0639

(57) ABSTRACT

A system including at least one first sensor coupled to a tool, the at least one first sensor outputting data about an operation of the tool, at least one second sensor, the at least one second sensor outputting physiological data of a worker operating the tool, at least one environmental sensor outputting data about an environment of the worker operating the tool, a database device storing patterns including historic data of the operation of the tool, historic data of the physiological data in connection with operation of the tool and historic data of the environment of the worker, and a processor comparing the data about the operation of the tool, the physiological data of a worker operating the tool and the data about the environment of the worker operating the tool to the database of patterns, the processor detecting at least one anomaly and generating at least one alert.

### BACKGROUND

The present disclosure relates to systems configured to monitor activity and detect abnormalities.

Worker safety is an important concern in the workplace. Poor training, exhaustion, task complexity and the like increase the likelihood of workplace accidents. Current systems for monitoring the state of workers are limited, unable to capture, in real time, subtle changes in a worker behavior.

### BRIEF SUMMARY

According to an exemplary embodiment of the present invention, a system includes at least one first sensor coupled to a tool, the at least one first sensor outputting data about an operation of the tool, at least one second sensor, the at least one second sensor outputting physiological data of a worker operating the tool, at least one environmental sensor outputting data about an environment of the worker operating the tool, a database device storing patterns including historic data of the operation of the tool, historic data of the physiological data in connection with operation of the tool and historic data of the environment of the worker, and a processor comparing the data about the operation of the tool, the physiological data of a worker operating the tool and the data about the environment of the worker operating the tool to the database of patterns, the processor detecting at least one anomaly and generating at least one alert.

According to an exemplary embodiment of the present invention, a method includes recording first data about an operation of a tool, recording second data including physiological data of a worker operating the tool, recording third data about an environment of the worker operating the tool, creating a digest combining the first, second and third data, storing, in a database device, patterns including historic data of the operation of the tool, historic data of the physiological data in connection with operation of the tool and historic data of the environment of the worker, comparing, by a processor, the data about the operation of the tool, the physiological data of a worker operating the tool and the data about the environment of the worker operating the tool to the historic data stored in the database device to detect at least one anomaly, and generating at least one alert upon detecting the at least one anomaly, wherein the at least one alert causes the tool to take an action.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
Identify typical usage conditions for equipment;
Identify typical environment conditions;
Identify typical worker conditions; and
Automatic identification of an alert upon deviations from typical patterns of conditions.

These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

Preferred embodiments of the present invention will be described below in more detail, with reference to the accompanying drawings:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is a flow diagram of a method according to an embodiment of the present invention;

FIG. 5 is a collection of exemplary graphs according to an embodiment of the present invention, wherein the graphs corresponding to certain events depicted in the flow diagram of FIG. 4;

FIG. 6 is a block diagram depicting an exemplary computer system embodying a method automatic text classification in a patient engagement application according to an exemplary embodiment of the present invention;

FIG. 7 is a flow diagram of a method for predicting accidents according to an embodiment of the present invention; and

FIG. 8 is a block diagram depicting an exemplary computer system embodying a method automatic text classification in a patient engagement application according to an exemplary embodiment of the present invention.

### DETAILED DESCRIPTION

According to an embodiment of the present invention, an ad hoc group of sensors is configured as a system for collecting contextual information and worker activity data. Collected contextual information and worker activity data is used by the system to infer typical behavior and to detect anomalies in behavior. More particularly, the system of ad hoc sensors detects, in real time, changes in worker behavior manifest as changes in the how the worker is interacting with the system. According to an embodiment of the present invention, these changes are indicative of unexpected modifications in physical conditions or behavioral patterns of the worker and can be used to predict future events, such as accidents.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

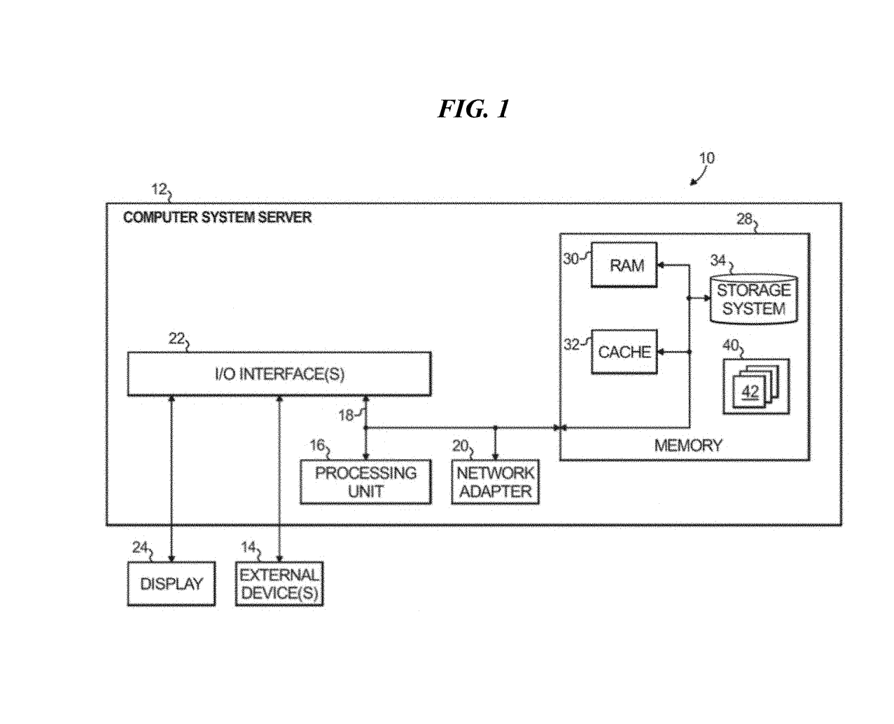

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

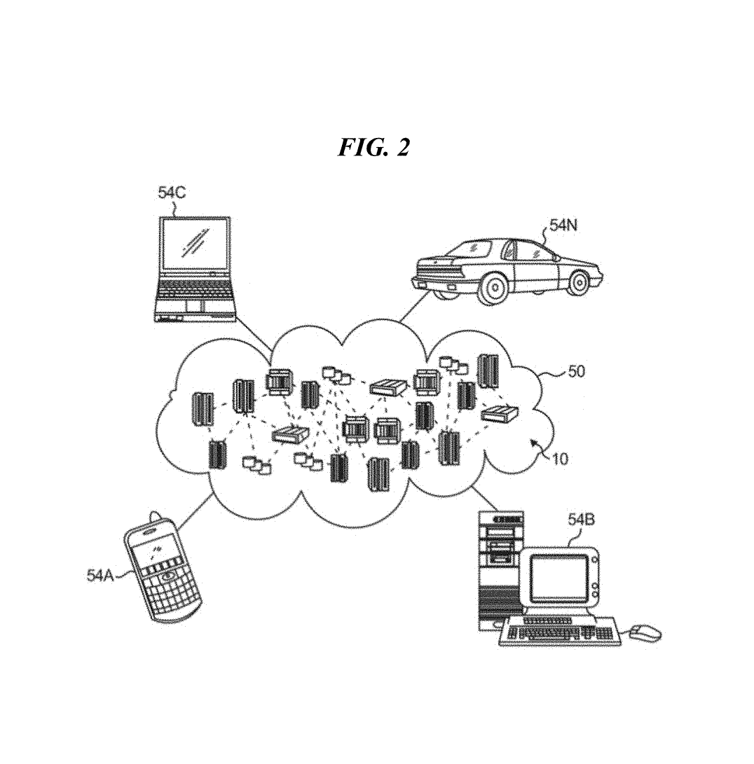

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

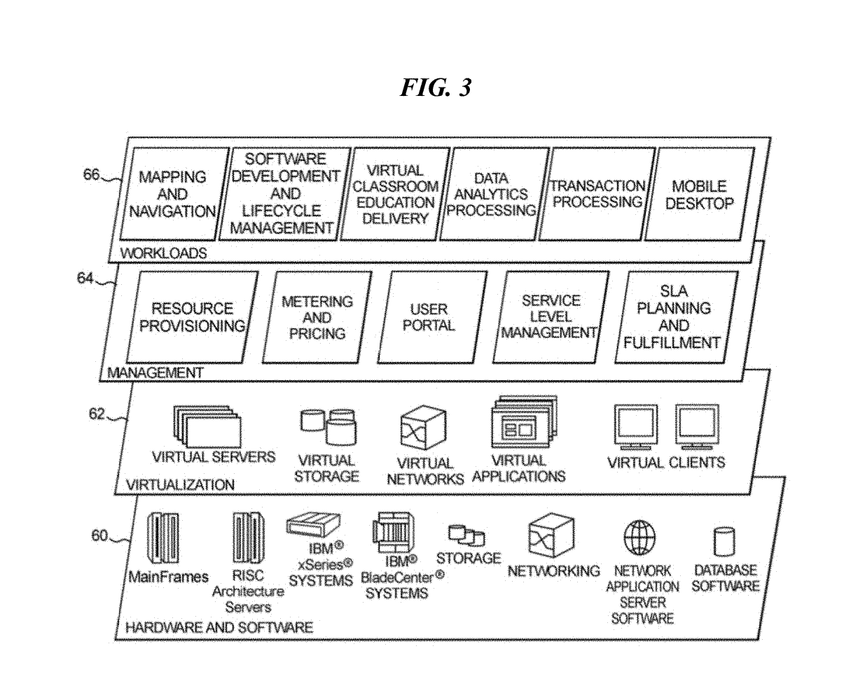

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM Web Sphere® application server software; and database software, in one example IBM DB2® database software. (IBM, zSeries, pSeries, xSeries, BladeCenter, Web Sphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

According to an embodiment of the present invention, a system comprises a user interface, a plurality of sensors (e.g., an Internet of Things (IoT) environment) and a network connecting the sensors.

According to an embodiment of the present invention, a method for monitoring worker status 400 includes data collection 402 from one or more sensors. The data collection 402 includes data-based identification of contextualized typical behavior in the workplace. According to an embodiment of the present invention, the data collection 402 includes identifying a task 401 that a worker is performing (or has performed) from usage and environmental data. For example, a task can be identified upon the worker entering a specified area of a shop floor (e.g., using a motion detector), upon powering on a given piece of equipment, or launching a given software application). This task corresponds to a context of the captured data, e.g., a worker performing task T defines a context C1 for later data analysis.

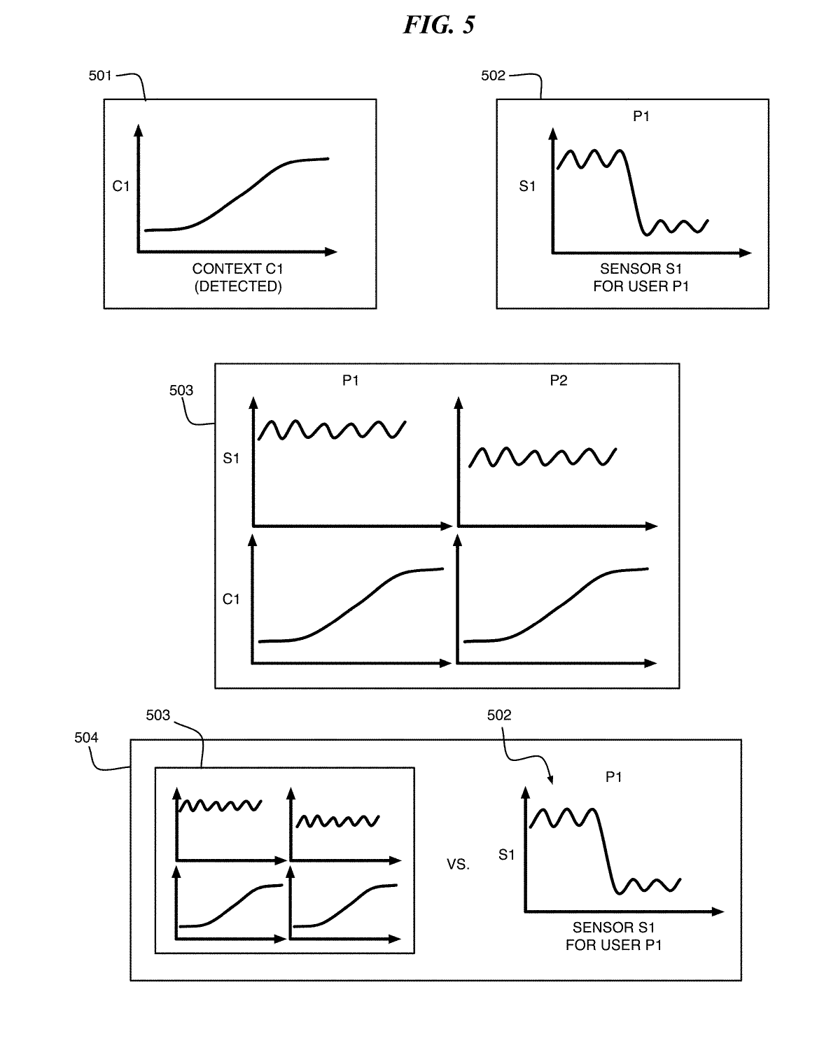

According to an embodiment of the present invention, usage/physiological data 403 (e.g., see FIG. 5, graph 501) is captured from equipment that the worker uses to perform the task, which may include multiple sensors (e.g., accelerometer connected to a control on the equipment, skin conductance using an electrodermal activity (EDA) meter, eye tracking using image analysis, etc.). According to an embodiment of the present invention, the environmental data 404 (e.g., see FIG. 5, graph 501) is captured using sensors supporting image capture/processing, measurement equipment (e.g., thermostats), etc. The environmental data can include information extracted from images, sounds, odors or scents, luminosity, etc.

According to an exemplary embodiment of the present invention, a data collector (data collection 402) gathers the captured data and creates a digest 405 combining the usage and environmental data related to the worker performing a task. In at least one embodiment of the present invention, the digest is a database comprising entries, where each entry contains a set of values such as a timestamp and a corresponding array of values output by one or more sensors. In at least one embodiment of the present invention, this array of values contains a group of values, where each value is produced by sensors monitoring the worker activity. For example, a force applied by the worker to a handle of the equipment or tool, a speed with which the worker turns the handle, a frequency with which the worker looks at an area of the equipment or tool, etc.

A current digest is applied to an individual patterns database 407 (e.g., see FIG. 5, patterns database 505) for the identified context 406 (e.g., C1 in FIG. 5) to detect deviations from the patterns stored in the patterns database 505 (see FIG. 5).

According to an embodiment of the present invention, outlier detection 408 is performed by determining a different of a currently observed value from earlier captured values. For example, if during the operation of a machine, the worker typically views a given module of the machine 80% (e.g., with +/−10% deviation) of a given time period (e.g., over a 5 minute window of time), and the system detects that the worker is currently looking at that module only 20% of the given time window, an outlier is detected, indicating a high probability that the worker is behaving in an unusual manner.

According to an embodiment of the present invention, if the current digest (e.g., graph 502 having context C1) is identified as an outlier 408, an alert is generated 409. Outlier detection (see FIG. 5, comparison 504) includes comparing the current digest 502 to patterns of the patterns database 407 having a same context (e.g., context C1). It should be understood that the comparison can be performed using a variety of techniques, such as a probabilistic matching method implementing a statistical approach in measuring a probability that two records (i.e., the current digest for an observed behavior and a pattern of the individual patterns database 407) represent a same behavior. The alert can be transmitted to one or more stakeholder devices 410 (e.g., by a message to a mobile device, email communication, etc.), which may include a risk manager, workers performing the task, and/or the equipment being handled.

In at least one embodiment, the alert is communicated to a control module 411 of the equipment (e.g., through a communications bus), wherein the control module 411 causes the equipment to perform an action, such as requiring a confirmation from the worker before continuing to a next task, or pausing a current task for a predetermined period of time. It should be understood that the alert can be used to cause a variety of actions, and that those described herein are exemplary and not limiting.

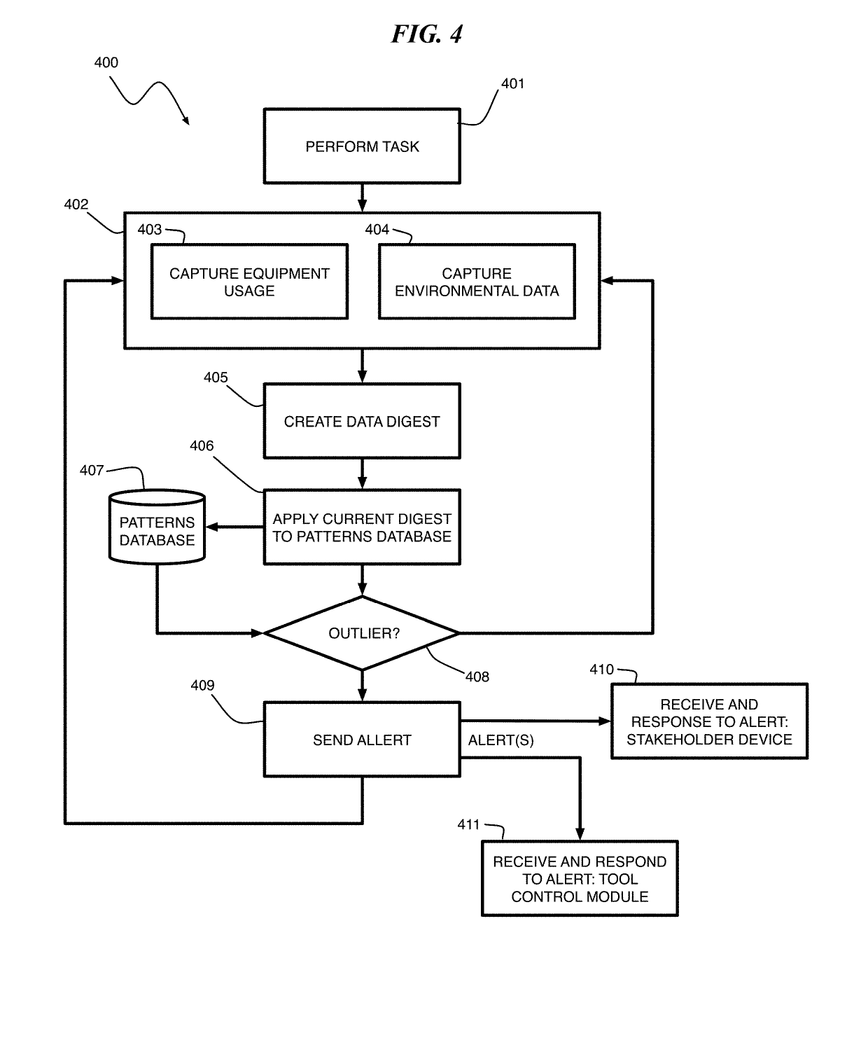

According to at least one exemplary embodiment of the present invention, at block 406 of FIG. 4, the patterns database 407 is automatically updated with newly collected patterns from the current digest. In at least one embodiment of the present invention, the patterns database 407 is updated with patterns of typical worker behavior (i.e., nominal patterns not determined to be outliers) and/or patterns of outlier behavior. According to one or more embodiments of the present invention, a re-calculation of nominal patterns and/or outlier patterns can be performed by data analytics and machine learning methods, including for example, average and standard deviation calculations, data clustering, etc.

According to at least one exemplary embodiment of the present invention, the identification of outliers at block 408 can be performed by determining that a current digest does not match any of the patterns contained in the patterns database 407 and/or that the current digest matches an example of outlier behavior contained in the patterns database 407.

In at least one exemplary implementation, historic data is used to verify if a certain behavior is likely to lead to an accident. For example, a worker cuts metal in a machine during working hours. During this process the worker needs to turn a handle. The handle is turned at a specific speed and strength. However, at a point in time, a set of sensors detects that the handle is operated at a different speed and strength. At this time, the system generates an alert, notifying a decision maker, or another piece of equipment, that an abnormal activity has occurred. In this example, the machine being manipulated by the worker relays the alert to the worker (e.g., through a graphical user interface), suggesting that the worker take a break.

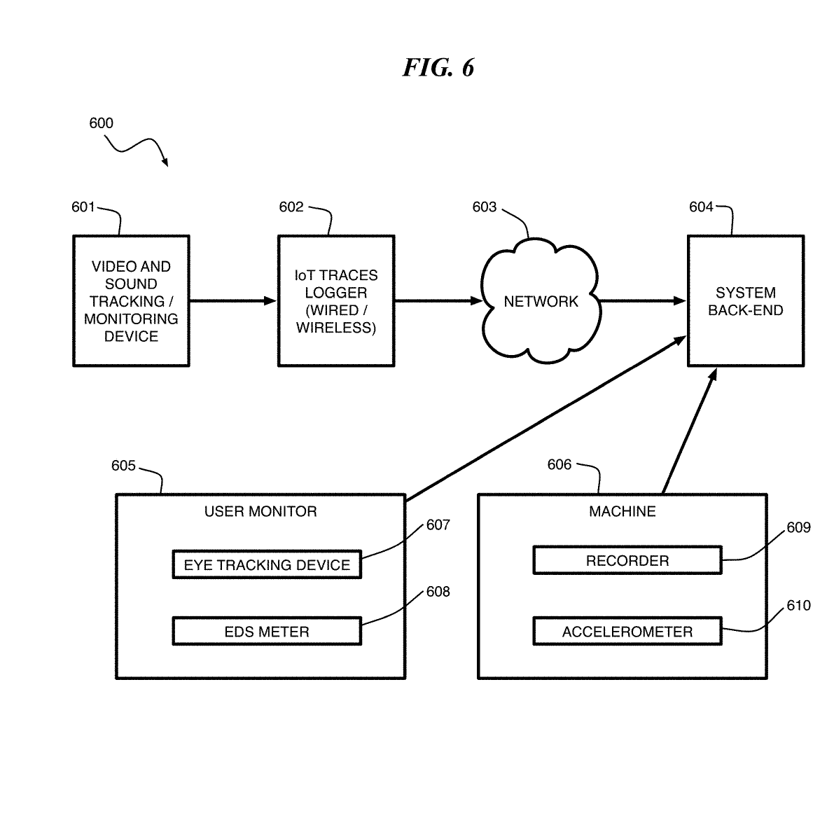

In another example, a worker performs a task that includes drilling holes in metal parts in the process of manufacturing cars. This task (i.e., drilling holes) is repeated frequently with the same set of tools. In this scenario, in the event that the worker departs from the task, for example, to assist a colleague in drilling a hole in a manner inconsistent with the task (e.g., in a material that the worker is not accustom to working with), one or more sensors detect that the worker is operating the drill in an atypical manner and that the worker's heartbeat is elevated (e.g., above a threshold established for a nominal value previously determined for the worker). The system generates and transmits an alert to a responsible manager to investigate the situation, where the manager can assist the employees and prevent a possible workplace accident. With reference to FIG. 6, a system 600 includes a video and sound tracking/monitoring device 601, an IoT trace logger 602 (wired and/or wireless), and a back-end system 604, connected to the IoT trace logger via a network 603, such as the Internet. Furthermore, the system 600 includes sensors configured to record data about the worker, about the tool and about an environment of the worker/tool. For example, a first sensor is a worker monitor 605 for tracking parameters of a worker. The worker monitor 605 can include, for example, an eye tracking system 607, an electrodermal activity (EDA) meter 608, etc. A second sensor 606 records parameters of the tool, e.g., a recorder 609 recording an image displayed on a graphical user interface of the tool (for example, to record what information a worker is using in operating the tool), an accelerometer 610 display on a handle of the tool to record a speed with which the tool is being manipulated, etc.

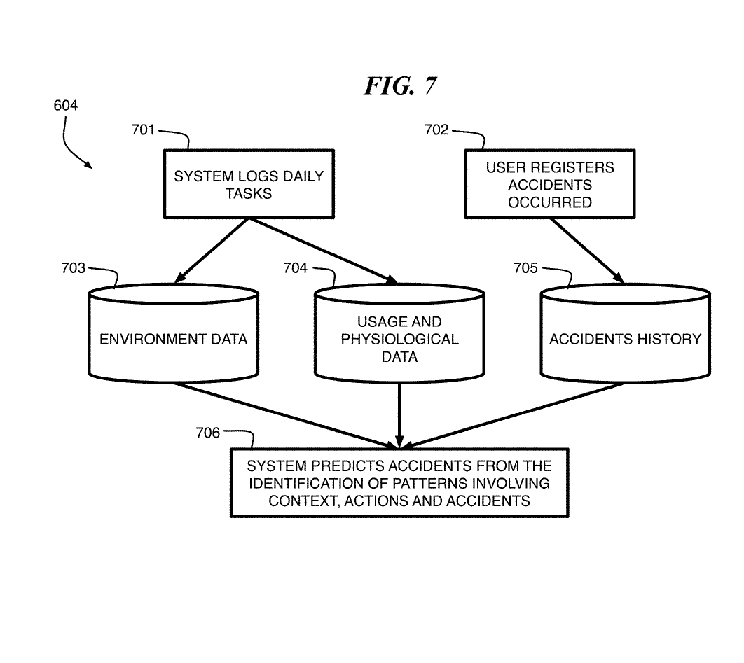

Referring to FIG. 7, the back-end system 604 receives system logs for dialing tasks 701 and information about accidents 702 and stores this data in a database structure including an environmental database 703, a database of useable and physiological data 704 and a history database 705. The back-end system 604 uses the data of the database structure to predict accidents by identifying one or more patterns. According to at least one embodiment of the present invention, the back-end system 604 uses context from the environmental database 703, actions described in the database of useable and physiological data 704 and historical data about accidents from the history database 705 to predict accidents.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system for automatic text classification in a patient engagement application. Further, a computer program product can include a tangible computer-readable recordable storage medium with code adapted to be executed to carry out one or more method steps described herein, including the provision of the system with the distinct software modules.

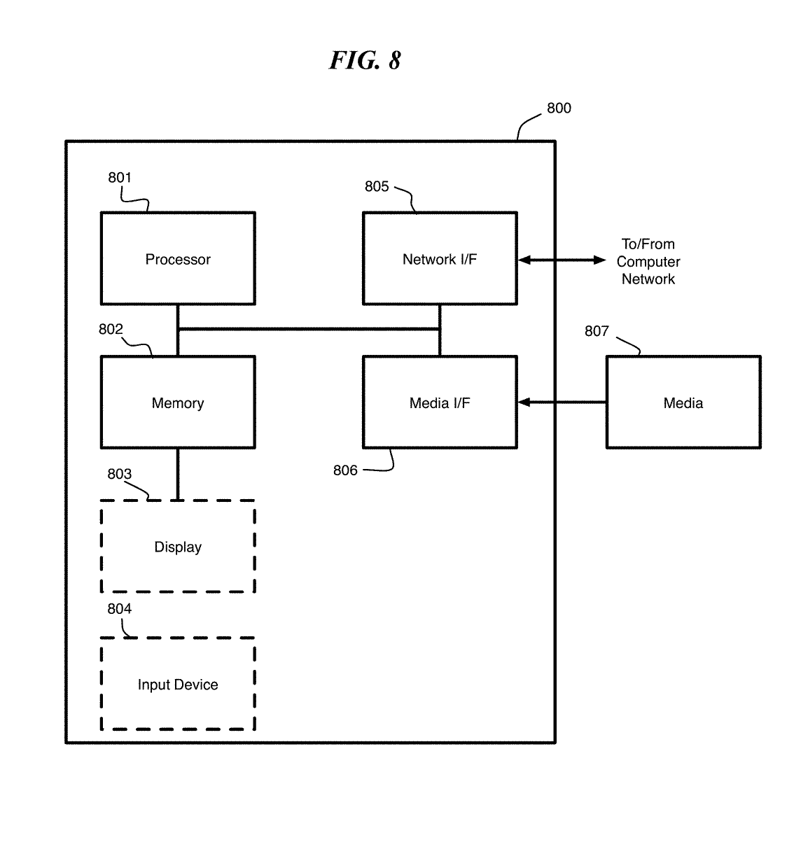

Referring to FIG. 8; FIG. 8 is a block diagram depicting an exemplary computer system embodying the computer system for automatically detecting deviations from workplace conditions (see FIG. 4) according to an embodiment of the present invention. The computer system shown in FIG. 8 includes a processor 801, memory 802, display 803, input device 804 (e.g., keyboard), a network interface (I/F) 805, a media I/F 806, and media 807, such as a signal source, e.g., camera, Hard Drive (HD), external memory device, etc.

In different applications, some of the components shown in FIG. 8 can be omitted. The whole system shown in FIG. 8 is controlled by computer readable instructions, which are generally stored in the media 807. The software can be downloaded from a network (not shown in the figures), stored in the media 807. Alternatively, software downloaded from a network can be loaded into the memory 802 and executed by the processor 801 so as to complete the function determined by the software.

The processor 801 may be configured to perform one or more methodologies described in the present disclosure, illustrative embodiments of which are shown in the above figures and described herein. Embodiments of the present invention can be implemented as a routine that is stored in memory 802 and executed by the processor 801 to process the signal from the media 807. As such, the computer system is a general-purpose computer system that becomes a specific purpose computer system when executing routines of the present disclosure.

Although the computer system described in FIG. 8 can support methods according to the present disclosure, this system is only one example of a computer system. Those skilled of the art should understand that other computer system designs can be used to implement embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
at least one first sensor coupled to a tool, said at least one first sensor outputting data about an operation of said tool;
at least one second sensor, said at least one second sensor outputting physiological data of a worker operating said tool;
at least one environmental sensor outputting data about an environment of said worker operating said tool;
a database device storing patterns including historic data of said operation of said tool, historic data of said physiological data in connection with operation of said tool and historic data of said environment of said worker; and
a processor comparing said data about said operation of said tool, said physiological data of a worker operating said tool and said data about said environment of said worker operating said tool to said database of patterns, said processor detecting at least one anomaly and generating at least one alert.

2. The system of claim 1, further comprising a control module of said tool, wherein said control module receives said alert and causes said tool to take an action in response to said alert.

3. The system of claim 1, wherein said at least one first sensor is one of an accelerometer connected to a control of said tool and a recorder recording an image displayed on a graphical user interface of said tool.

4. The system of claim 1, where said at least one second sensor is one of an electrodermal activity (EDA) meter and eye tracking system.

5. A method comprising:
recording first data about an operation of a tool;
recording second data including physiological data of a worker operating said tool;
recording third data about an environment of said worker operating said tool;
creating a digest combining said first, second and third data;
storing, in a database device, patterns including historic data of said operation of said tool, historic data of said physiological data in connection with operation of said tool and historic data of said environment of said worker;
comparing, by a processor, said data about said operation of said tool, said physiological data of a worker operating said tool and said data about said environment of said worker operating said tool to said historic data stored in said database device to detect at least one anomaly; and
generating at least one alert upon detecting said at least one anomaly, wherein said at least one alert causes said tool to take an action.

6. The method of claim 5, wherein creating said digest comprises generating an entry in said digest.

7. The method of claim 6, wherein generating said entry in said digest comprises:
recording a timestamp; and
recording a value output by at least one of sensor recording at least one of said first, second and third data, wherein said value is associated with said timestamp.

8. The method of claim 5, further comprising updating said patterns stored in said database device.

9. The method of claim 8, wherein said patterns stored in said database including a plurality of nominal patterns and updating comprises recalculating said plurality of nominal patterns.

10. The method of claim 8, wherein said patterns stored in said database including a plurality of outlier patterns and updating comprises recalculating said plurality of outlier patterns.

11. A monitoring system comprising:
a data collection means recording first data about an operation of a tool, recording second data including physiological data of a worker operating said tool, recording third data about an environment of said worker operating said tool;
a database device storing a plurality of patterns and creating a digest combining said first, second and third data, wherein said plurality of patterns include historic data of said operation of said tool, historic data of said physiological data in connection with operation of said tool and historic data of said environment of said worker;
a comparison means comparing said data about said operation of said tool, said physiological data of a worker operating said tool and said data about said environment of said worker operating said tool to said historic data stored in said database device to detect at least one anomaly; and
a means for generating at least one alert receiving said at least one anomaly and generating an alert, wherein said alert causes said tool to take an action.

12. The monitoring system of claim 11, wherein said database device generates an entry in said digest.

13. The monitoring system of claim 12, wherein said database device, in generating said entry in said digest, records a timestamp; and records a value output by at least one of sensor of said data collection means recording at least one of said first, second and third data, wherein said value is associated with said timestamp.

14. The monitoring system of claim 11, further said database device updates said patterns stored in said database device.

15. The monitoring system of claim 14, wherein said patterns stored in said database including a plurality of nominal patterns and said updating comprises recalculating, by said database device, said plurality of nominal patterns.

16. The monitoring system of claim 14, wherein said patterns stored in said database including a plurality of outlier patterns and updating comprises recalculating, by said database device, said plurality of outlier patterns.
